(19) United States
(12) Patent Application Publication
(10) Pub. No.: US 2016/0050376 A1
(43) Pub. Date: Feb. 18, 2016

(54) Image sensor with sub-wavelength resolution

(71) Applicant: Ron Fridental, Shoham (IL)

(72) Inventor: Ron Fridental, Shoham (IL)

(21) Appl. No.: 14/461,456

(22) Filed: Aug. 18, 2014

(51) Int. Cl. H04N 5/359; H04N 5/369

(52) U.S. Cl. CPC H04N 5/359; H04N 5/369

(57) ABSTRACT

Disclosed are the architecture solutions and signal processing methods, allowing manufacturing, calibration and operation of the image sensor with sub-wavelength size and spacing of the pixels for sub-wavelength and diffractive imaging, and subwavelength contact microscopy, microfluidics and other related applications.

### CROSS REFERENCE TO RELATED APPLICATIONS

None

### STATEMENT REGARDING FEDERALLY SPONSORED RESEARCH OR DEVELOPMENT

Not Applicable.

### REFERENCE TO SEQUENCE LISTING

Not Applicable.

### TECHNICAL FIELD

The present disclosure relates to the fields of digital microscopy and digital imaging.

### REFERENCES CITED

### U.S. Patent Documents

[1] U.S. Pat. No. 4,917,462 August 1989 A. Lewis et. al.

### Foreign Patent Documents

### Other Publications

[2] M. Born, E. Wolf; “Principles of Optics”; Cambridge University Press, 1999

### BACKGROUND

Optical microscopes are proved to be an important instrument of scientific and technological research. The optical microscopes traditionally comprise an optical system which forms the image of an object projected either onto the retina of human eye or onto the image sensor. The maximum resolution of optical microscopes is limited by diffraction of the optical systems, and cannot exceed the so called diffraction limit.

Diffraction limit on resolution of the optical systems is a fundamental physical principle of optics, which derives from the wave nature of light, and results in inevitable limitation of resolution of optical systems, which approximately equals the wavelength times the relative aperture of the optical system. More detailed explanation and accurate estimates can be found in [2]. However these limitations are relevant only for imaging systems that create an image of an object. Much higher optical resolution had been demonstrated by the optical near field microscopes and contact lithography techniques in semiconductor manufacturing industry.

The optical scanning near field microscopes [1] are based on the optical fiber waveguide which sequentially scans the surface of the investigated object, and creates the image of the scanned object line by line from the scanning results. The size of the scanning tip of the optical fiber waveguide and its distance from the object can be less than the light wavelength, providing the sub-wavelength resolution of the image.

However the shortcomings of the scanning near-field microscope are its slow speed, and small light sensitivity, due to the sequential image acquisition process of one pixel at a time via a tiny input hole of the waveguide tip. Moreover, optical near field microscopes are relatively bulky, expensive and delicate devices, which complicates or prohibits their use in many applications. Thus the better solution that improves over the above limitations of near field microscopes is much needed.

### BRIEF SUMMARY

It is an object of the present invention to provide several solutions related to sub-wavelength imaging and microscopy. For this we disclose a Sub Wavelength imaging Array (SWA), where the size of the pixels and separation between the neighbor pixels is less than the wavelength of the operating bandwidth. Names image sensor, sub-wavelength image sensor, sub-wavelength pixel array, SWA, pixel array and similar may be used interchangeably to refer to SWA in this disclosure.

The conventional art teaches us, that such sub-wavelength array is impossible to manufacture and use for several reasons:

(1) Sub-wavelength array will have the individual pixels of the size less than the wavelength, which means less than about 0.5 micrometer for the visible band imaging, and it could not be successfully manufactured in the past due to tiny size of the pixels and their internal circuitry. However the improved resolution of the semiconductor manufacturing now allows to overcome this limitation, and further shrinking of the pixel size will be possible in the future.

(2) Diffraction limit on resolution of the optical systems is a fundamental physical principle of optics, which derives from the wave nature of light, and results in inevitable limitation of resolution of optical systems. Δx=2.44λF, where λ is the wavelength, and F is the relative aperture, defined as focal length divided by lens aperture. More detailed explanation and accurate estimations can be found in [2]. Since for visible bandwidth 0.4 μm≦λ≦0.7 μm; for most optical systems, F≧1.4; we obtain the resolution limit Δx≧1.9 μm.

The diffraction limit on the resolution derives from fundamental physics and cannot be directly overcome. To overcome this limitation, we place the imaged object immediately adjacent to the sub-wavelength array, and we eliminate the optical system in between. This results in the much smaller limit on the resolution. That is due to the fact that the absence of imaging system equals to tiny relative aperture, and in that case the resolution limit can be calculated by physical simulation of electromagnetic field pattern. The examples of similar configurations are near-field systems such as a scanning near-field microscope, where the optical fiber with sub-wavelength opening scans over the object, and sub-wavelength optical lithography. These systems demonstrate sub-wavelength resolution (Δx<λ), which for the visible band (0.4 um≦λ≦0.7 um) translates into: Δx<0.5 um. The exact resolution can be calculated by near-field optical calculation in accurate physical simulations, as described in [2].

(3) Closely spaced pixels in dense image sensors are known to have significant crosstalk, when the light that should contribute to particular pixel eventually contributes to its neighbor pixel. This crosstalk can be caused by optical scattering of the photons before the conversion into electric carriers (optical crosstalk), or by the scattering of electric carriers within the semiconductor (electrical crosstalk).

Here we disclose the novel architecture solutions for pixels, boundaries between the pixels and image sensor array, as well as the novel test structures and image processing methods that eliminate or significantly decrease the neighbor pixel cross-talk.

The disclosed architecture solutions to decrease the crosstalk include use of optical isolation between the neighbor pixels; thinning of active light sensing layer; use of additional p-n transition areas below the pixel and between the neighbor pixels in order to collect and drain out the stray carriers; use of semiconductor etch in the boundary between the neighbor pixels for electrical and optical isolation between the adjacent pixels; use of novel calibration structures to measure the pixel cross-talk, which are used stand alone or integrated into the image sensor; use of signal processing eliminating or decreasing the cross-talk via deconvolution of crosstalk from the acquired image.

Multiple different uses and applications of the disclosed sub-wavelength array are possible, such as:

(1) Microfluidic systems, and lab on a chip systems, which are the micro-systems for medical, chemical, biological analysis and synthesis used for applications, where SWA can be integrated into the system and used as optical microscopy imaging and analysis tool. For liquid flow control in microfluidic applications of SWA, we disclose the electrostatic phased array integrated with SWA.

(2) Diffractive imaging, where not the image of the object, but rather a diffraction pattern created by the object is imaged. The diffraction pattern can have features of sub-wavelength size, and therefore diffractive imaging can require sub-wavelength resolution. Diffractive imaging can be produced under monochromatic or narrow bandwidth illumination, or can be facilitated by narrow band-pass filter deposited over the sub-wavelength image sensor.

(3) Use of the SWA in various systems: sub-wavelength microscope, contact microscope, scanners, micro-electro-mechanical system (MEMS), high resolution digital cameras, and other imaging and electro-optical systems, at least in all the fields, systems, devices and applications where the prior art image sensors are currently used.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of a sub-wavelength imaging array (SWA);

FIG. 2 is a schematic illustration of a part of SWA, illustrating the schematic of individual pixels;

FIG. 3 is a schematic drawing of a test structure for pixel cross-talk calibration;

FIG. 4 is a schematic drawing of part of a sub-wavelength imaging array with integrated pixels for cross-talk calibration;

FIG. 5 is a flowchart of a pixel cross-talk measurement and correction;

FIG. 6 is a schematic drawing of pixel cross-section illustrating architecture solutions for cross-talk reduction;

FIG. 7 is a schematic drawing of pixel cross-section illustrating additional architecture solutions for cross-talk reduction;

FIG. 8 schematically shows a SWA with an object over it.

FIG. 9 is a schematic illustration of the imaging unit comprising an SWA, which operation is controlled by SWA controller and output data is processed by SWA ISP.

FIG. 10 is a schematic illustration of electrostatic phased array for microfluidics flow control.

FIG. 11 is a schematic illustration subwavelength imaging array with integrated electrostatic flow control.

FIG. 12 illustrates a microfluidic system comprising a sub-wavelength imaging array.

### DETAILED DESCRIPTION

The disclosed subject matter is described below with reference to the enclosed drawings.

One technical problem dealt with by the disclosed subject matter is the imaging of the objects details finer than the wavelength of the operating bandwidth. There were at least two limitations prohibiting such imaging in the prior art.

The first limitation is the diffraction limit of the optical systems. In the conventional microscopes and imaging systems there is an optical system forming an image of the object on the image sensor. The resolution Δx of this optical system cannot exceed the diffraction limit, Δx≧2.44λF. The relative aperture F of optical systems almost always exceeds 1.4: F≧1.4, the wavelength λ of visible band is 0.4 μm≦λ≦0.7 μm (micrometer), average wavelength λ≈0.55 μm and therefore the diffraction limit for optical systems in the visible bandwidth is about Δx≈2.44·0.55 μm·1.4≈1.9 μm (μm denotes micrometer).

The diffraction limit on the resolution is relaxed in the near-field systems where the object is closely adjacent to the imaging plane, and no optical system is placed between the object and the imaging element. The examples of near-field optical systems, with resolution exceeding the light wavelength are scanning near-field microscopes, where the optical fiber with opening smaller than the operating wavelength is scanned along the object, and the contact mask lithography where the resolution better than the wavelength is obtained.

However we do not limit the applications of disclosed sub-wavelength image sensor to the near-field domain. In some applications it can be advantageous to have a sub-wavelength sensor resolution even if the optical system has lower resolution.

The second limitation of prior art is a significant cross-talk between the neighbor pixels of existing image sensors, which increases with decrease of the pixel size and distance between the neighbor pixels.

Here we disclose the pixel and architecture, calibration structures and image processing methods that eliminate or significantly decrease the pixel cross-talk.

The disclosed architecture solutions to decrease the crosstalk include use of optical isolation between the neighbor pixels; thinning of active light sensing layer; use of additional p-n transition areas below the pixel and along the boundary between the neighbor pixels in order to collect and drain out the stray carriers; use of semiconductor etch in the boundary between the neighbor pixels for electrical and optical isolation between the adjacent pixels; use of calibration structures to measure the cross-talk; use of signal processing to eliminate and decrease the cross-talk by measuring the point spread function of the crosstalk on the disclosed test structures, and further de-convoluting the crosstalk from the acquired image.

Microfluidic systems are the micro-systems for medical, chemical, biological analysis and synthesis. In medical and biological microfluidic systems liquid sample analysis may include optical detection, identification and counting of particles in the liquid sample, such as blood, or other medical or biological sample. SWA integrated as part of microfluidic system may acquire images or video stream of the sample liquid flowing over it, and illuminated by ambient illumination or dedicated light source. The automatic image and video processing of acquired images or video stream may allow to detect, identify and count the specific particles, cells, bacteria or viruses, and use the obtained results as the system output or intermediate data for further chemical or biological analysis, medical diagnostics or system control.

One of the important tasks that microfluidic systems are dealing with is the pumping and transportation of the fluid sample along the system. One of the known methods is electrostatic pumping, where electrostatic field or change of surface properties at the liquid/surface boundary creates a force, moving the liquid. Here we disclose the architecture integrating the imaging array with electrostatic phased array for liquid pumping.

Diffractive imaging is the field were high resolution imaging by SWA will be advantageous. In the diffractive imaging, the diffractive pattern created by the object is imaged. It can be further used for 3D shape reconstruction of the object, creation of holographic image of the object, and in various other applications. The diffraction pattern can have features of sub-wavelength size, and therefore diffractive imaging can benefit from sub-wavelength resolution of SWA. Diffractive imaging system may comprise and SWA, with optional illumination source and optional processing unit. Illumination source may be monochromatic. Optionally the active bandwidth of SWA may be limited by covering it with band-pass filter, or by other way.

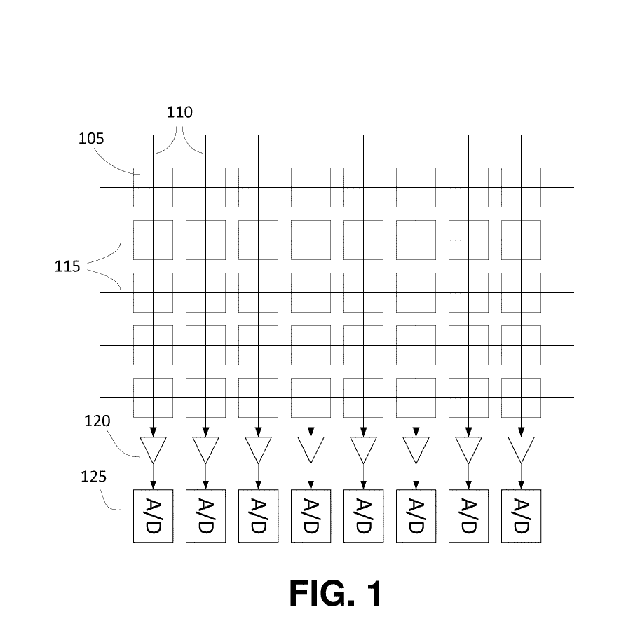

FIG. 1 is a schematic illustration of a sub-wavelength pixel array. 105 is a single pixel; 110 are the column read-out lines, 115 are the row select lines, 120 is an optional analog read-out amplifier, while 125 is an Analog to Digital converter. The light falling onto a pixel is converted into electrical signal. The way of the conversion is defined by the pixel architecture and operation mode. It is known in the art, that selecting the particular row line provides the output of voltage of pixels of that particular row on each column read-out line. It may be further amplified or buffered by optional amplifiers 120, and finally converted from analog value into binary digital value in A/D converters 125, for further processing, storing or transmitting.

The invention is not limited to any specific pixel architecture, operation mode or layout of the pixels within the array. Multiple variants of the pixel architecture may be implemented (linear pixel, logarithmic pixel, pixel with electronic shutter and other types), various operation modes such as single frame, multiple frames, video, high dynamic range imaging, may be applied; multiple layout of the pixels within the array (rectangular grid, honeycomb, pixels of varying sizes, radial array, and other known or future types) may be used;

Various mechanisms of conversion of light into electrical signal (closed photodiode, photo-transistor, and other types), mechanism of pixel selection, reset and read-out are possible. Various types of semiconductor including indirect band-gap semiconductors, such as semiconductors comprising Si, Ge, C elements and their dopants, and direct band-gap semiconductors, such as semiconductors comprising Ga, As, In, P, Al, N elements may be used.

The disclosed SWA may be used in any band or sub-band of electromagnetic spectrum within the wavelength range of 0.1 um-2.0 um. For example in the visible bandwidth of 0.4 um-0.7 um, infrared bandwidth 0.7 um-1.1 um, ultra-violet bandwidth 0.2 um-0.4 um or other bandwidths.

The term sub-wavelength is used in the meaning, that if the array is sensitive, for example, in the visible band 0.4 um-0.7 um, (um denotes micrometer) then at least one of the dimensions of the pixel or separation between the pixels in at least one direction is less than 0.7 um.

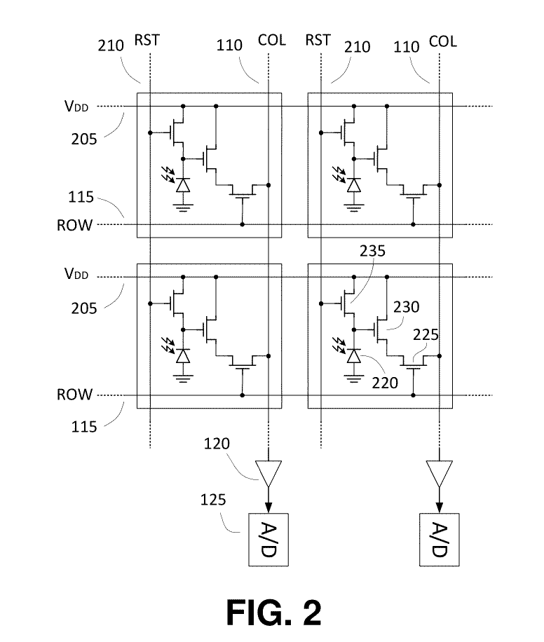

FIG. 2 shows a partial region of the subwavelength imaging array, illustrating one of the possible embodiments of pixel architecture. 210 are the reset lines; when selected they open the gates of the reset transistors 235, and the photosensitive diodes 220 are recharged at the beginning of the frame exposure. The reversely biased, and naturally closed photo-diode 220 is discharged by photocurrent under illumination by light, and the discharge rate is proportional to light intensity, thus the voltage decrease is proportional to light intensity multiplied by integration time. The voltage on the photo-diode is sensed and buffered by source-following output buffer transistor 230. When read-out transistor 225 is selected by ROW select line 115, it transmits the pixel output voltage towards the column read out line 110 via an optional amplifier towards an A/D converter 125 where it is finally digitized for further reading and processing. The disclosed invention is not limited to that particular pixel schematic, and can incorporate many other types and variations of pixel schematic.

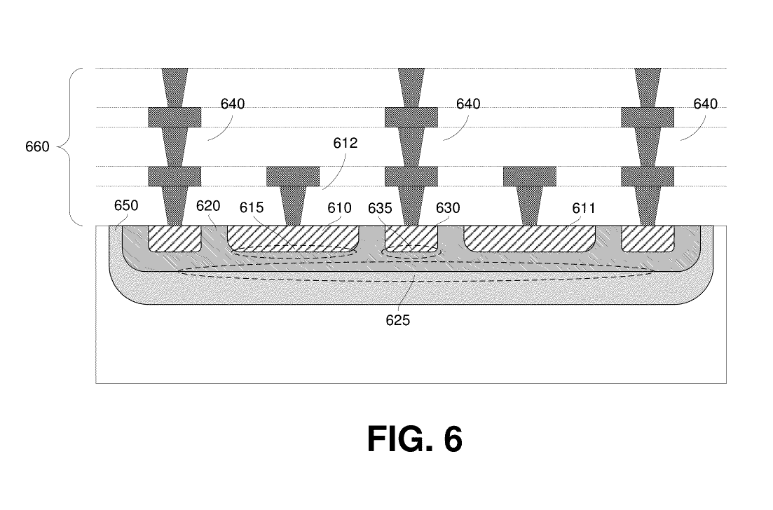

If the additional structures for cross-talk reduction, that are illustrated on FIG. 6 and described below are implemented in the SWA, they will need additional circuitry for Reset (RST lines) and Biasing (Vdd lines), this additional circuitry is not shown in the drawing for the sake of simplicity, as it is obvious for a person sufficiently skilled in the art.

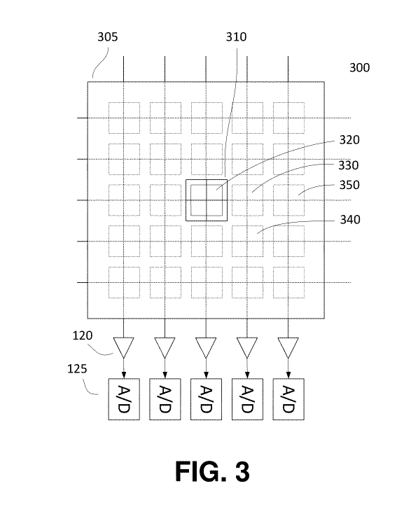

FIG. 3 is a schematic drawing of the crosstalk calibration SWA structure. It has the same design and as the primary SWA, but the array is shielded with metal or other light-blocking layer 305. It may be manufactured on the same die with SWA, or be a part of the primary SWA, placed on the periphery or in the corner.

The calibration SWA is closed by an optically shielding layer 305 with an opening window 310. In ideal case, when the pixel cross-talk is absent, all the light signal would be sensed by pixel 320, and zero signal would be sensed by pixels 330, 340, and 350. However due to the neighbor pixel cross-talk, some light or generated carriers will be leaked from pixel 310 towards its neighbor pixels. The crosstalk calibration structure 300 allows to measure this cross-talk, and later take it into account for cross-talk deconvolution of images acquired by SWA.

The cross-talk calibration structure may have an inverse shielding, when the central pixel 310 is shielded by light-blocking layer, and all the other pixels are open. In that case, the signal will be lowest on pixel 310, and will be decreased due to cross-talk on its neighbor pixels. This is due to the fact that the signal of the remote pixels is composed of the light that falls directly onto them, and also partially of the cross-talk from the neighbor pixels. However, the cross-talk contribution from the shielded pixel is decreased, therefore decreasing the value measured on its neighbors.

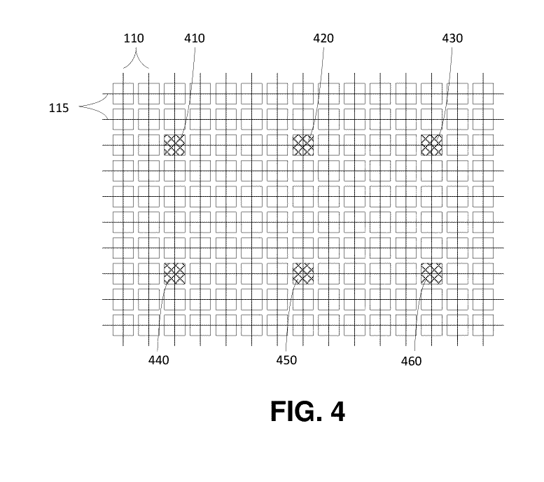

FIG. 4 illustrates a partial region of SWA with the grid of shielded calibration pixels. The clear squares denote the regular operating pixels, while the shaded squares 410, 420, 430, 440, 450, 460, denote the optically shielded pixels. In this example the shielded pixels form a regular sub-grid within the grid of the SWA, and the distance between the shielded pixels is 5 pixels of SWA in both horizontal and vertical directions. In practical cases other distance may be chosen, not necessarily equal in horizontal and vertical directions, and not necessarily as a regular grid. Any number of shielded pixels starting from a single pixel may be uses.

The inverse calibration structure has advantages, since it does not need any dedicated stand-alone calibration structure: a single or few scattered pixels of the SWA may be shielded, while majority of pixels will remain unshielded and fully operational. The single or few shielded pixels allow the cross-talk calibration, while the rest of the pixels (which constitute the majority) allow the operation and imaging by SWA. The image value under the shielded pixels can be reconstructed by interpolation of the values of neighbor pixels, or other image processing techniques known in the art.

For example, for SWA matrix of million pixels of size 1000×1000 pixels, only 100 pixels scattered as the grid at the positions X=50, 150, 250, . . . 950; and Y=50, 150, 250, . . . 950 can optically shielded, while all the other pixels kept clear.

The information from the SWA with calibration shielded pixels may be used in multiple ways. One of the ways is to acquire a calibration image when there is no object, and the SWA is illuminated uniformly. From signal decay of the pixels neighboring the each shielded pixel the cross-talk between the pixels is obtained. All the neighbors together yield the signal point-spread function, or the blurring kernel. Multiple shielded pixels allow to obtain more accurate results, via averaging, and decreasing the noise, illumination and manufacturing non-uniformity.

Alternative way is to calculate the blurring kernel from the operating image itself. Despite the non-uniform and un-known in advance image presenting in the captured image, averaging over the multiple shielded pixels and their vicinities allows to separate between the image content, and blurring kernel. Further averaging is possible due to the fact that blurring kernel should be symmetric under operations of mirroring and rotation.

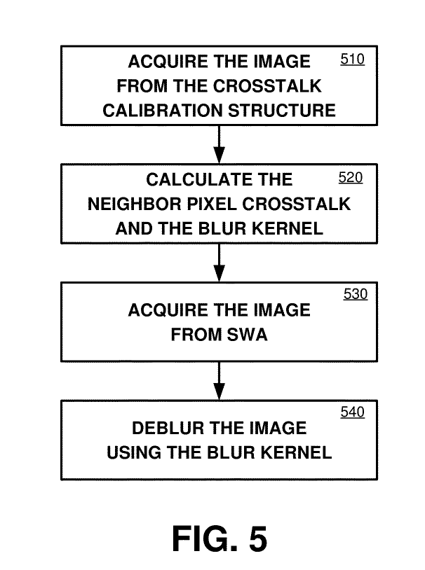

FIG. 5 is a flowchart, illustrating the pixel cross-talk deconvolution with the help of the cross-talk measurements from calibration structure from FIG. 3 or FIG. 4. After the image from the crosstalk calibration structure is acquired in step 510, the neighbor pixel crosstalk and the blur kernel are calculated in step 520. The crosstalk between any two pixels A and B is defined as the part of the signal that leaked from pixel A to pixel B. For example, if the pixel A is open, and all the rest of the pixels including the pixel B are optically shielded, than the signal measured by B is actually the signal that leaked from A. The blur kernel K is the matrix, which elements quantify the relative part of the signal that leaked to the corresponding pixels. The blurred image Y is the result of convolution of the unblurred image I with the blur kernel K: Y=K*I

Image acquisition and deblurring on the basis of the measured blur kernel is performed in step 530. Image deblurring is the inverse problem of obtaining unblurred image I from the blurred image Y. Multiple ways of image deblurring facilitated by the knowledge of the blur kernel K are known in the art, including application of inverse or pseudo inverse kernel: I=inv(K)*Y; solution of the least squares problem: I=arg(min(Y−K*I)̂2) and others. It is known in the art of image and signal processing, that knowledge of the blur kernel generally eases the deblurring, and improves its accuracy.

For the calibration method of FIG. 4, when the isolated optically shielded pixels are scattered across the SWA, the steps 510 and 530 will be combined, because the image acquired from SWA will also contain the data from optically shielded pixels and their neighbors.

The execution order of the flow-chart in this case would be: Step 510 and 530, followed by step 520, followed by 540.

FIG. 6 shows a schematic cross-section of the image sensor to illustrate the pixel solutions reducing the crosstalk. Different types of doping profiles and concentrations, types of dopants, are known and distinguished in the art, and may be varied in the disclosed device architecture. Nevertheless for the sake of clarity, we define the types of region doping here in simplistic way as n-type and p-type, and omit all the unnecessary details. Furthermore, the n and p types of semiconductor can be altered, while maintaining the functionality of the disclosed inventions.

610 is the n-type region of photodiode—the core photosensitive element of the pixel; 611 is the same region of its neighbor pixel. 620 is the p-type region, to form a photodiode with regions 610, 611 (e.g. if regions 610 are of n-type, then 620 is of p type, and vice versa).

615 is the closed p-n junction of the photodiode, formed by applying the reverse bias to the pixel photodiode during the pixel exposure time. It corresponds to the photo diode 220 of FIG. 2.

612 is the contact of the pixel photodiode.

The first novel disclosed structure reducing the pixel crosstalk is formed by the additional doping region of n type 650 below the pixel, which is reversely biased to form a closed p-n junction 625. The junction thickness may be increased by low-concentration doping, to form a p-i-n structure. This reversely biased junction creates an electric field absorbing the scattered carriers that escaped the working photodiode junction 615 before they reach the junction of adjacent pixels, therefore reducing the neighbor pixel crosstalk.

The second novel disclosed structure reducing the optical pixel crosstalk is the optical isolation between the neighbor pixels by the wall of metal layers and via-connectors between them, shown as 640. It may be extended through the part, or the whole height of backend dielectric layers 660.

Another method to reduce the neighbor pixel cross-talk is to decrease the height of the backend layer 660.

The third novel disclosed structure reducing the electrical pixel crosstalk is the additional closed diode structure along the boundary between the pixels, shown as doped region 630 and reversely biased closed diode 635.

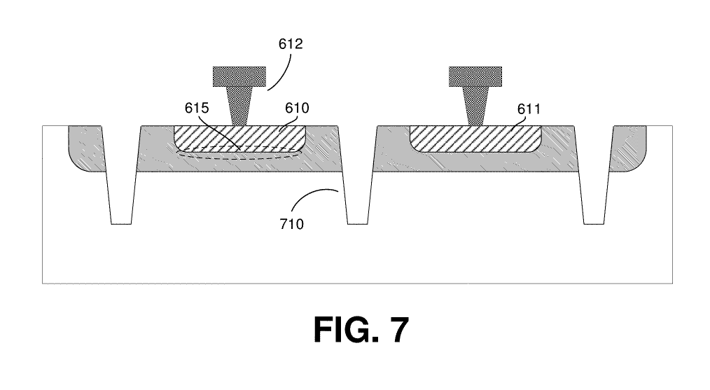

FIG. 7 shows another novel structure reducing the pixel crosstalk. It is the channel 710 that is etched along the boundary of the neighbor pixels that stops the drift of stray electrons and scattering of the unabsorbed photons in the semiconductor bulk. It may be filled by optically blocking material, such as metal or dielectric or other type. It may be specially doped and provided with conductor control, to form an isolated diode structure, similar to 635, but with 3D geometry defined by etching.

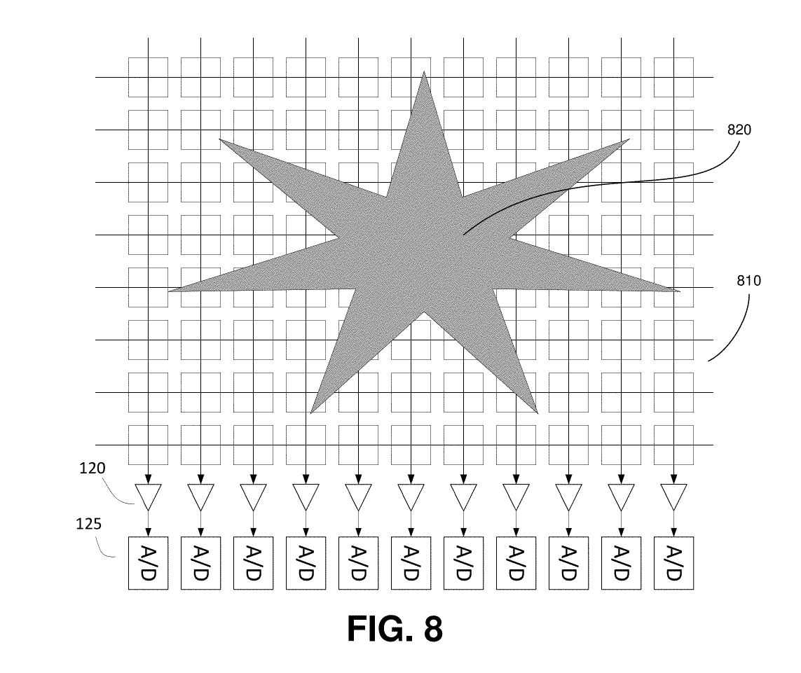

FIG. 8 schematically shows a sub-wavelength imaging array with an object over it, during imaging. 810 is an imaging array, 820 is an object, lying adjacent to the imaging array.

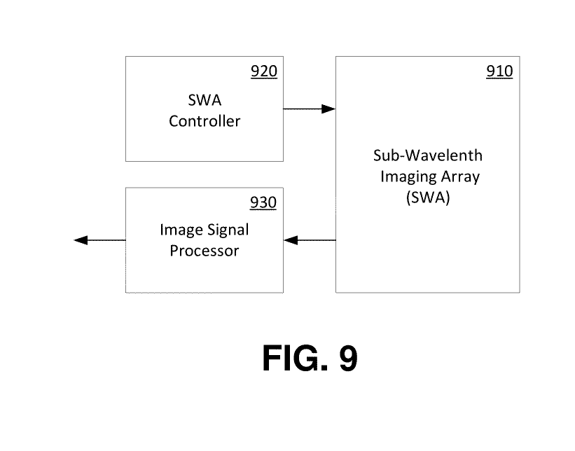

FIG. 9 is a schematic illustration of the imaging system comprising a controller, and image signal pipeline and a sub-wavelength imaging array. 920 denotes an SWA controller, which may be implemented as an integrated circuit and software running that operate and control the subwavelength sensor. An example of such operation may be setting the frame rate, exposure period, amplifier gain, read-out order and mode, etc. 930 is an ISP module, which purpose is the processing of the imaging data obtained from SWA 910. An example of ISP processing may be de-blurring of the image, possibly using the procedures described in other sections of this disclosure, de-noising, change of contrast, color processing and or demosaicing, in the case of color mosaic covered image sensor, and other image processing methods known in the art or developed for specific applications of subwavelength sensor.

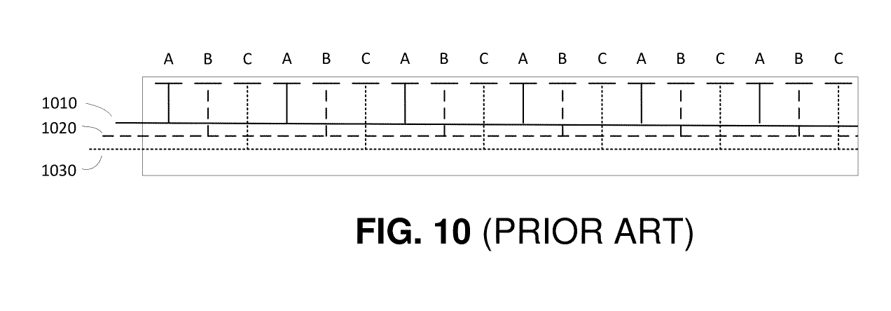

FIG. 10 illustrates the electrostatic phased array for electrostatic fluid transporting, which is known in the digital microfluidics. It contains of several (usually three) overlapping grids A, B, and C, with separate voltage supplies 1010, 1020, 1030. Electrostatic or electro-wetting forces move the droplet, while the grids are voltage sequentially, with appropriate phase delay.

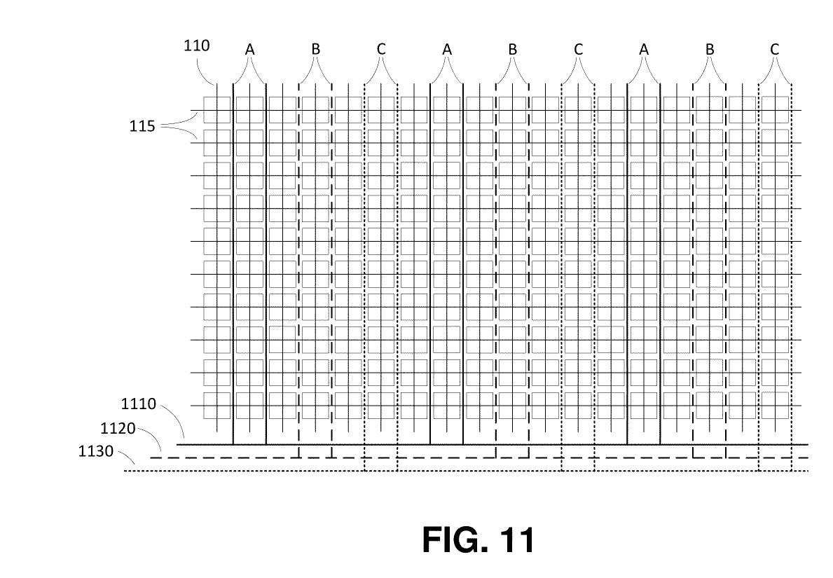

FIG. 11 illustrates the subwavelength imaging array with integrated e electrostatic phased arrays A, B, and C for electrostatic fluid transporting. The grids voltages are supplied via the contacts 1110, 1120, and 1130. The step between the grids bay differ from the steps between the pixels, for example, on FIG. 11, every 6 columns of SWA correspond to single cycle of A/B/C grids.

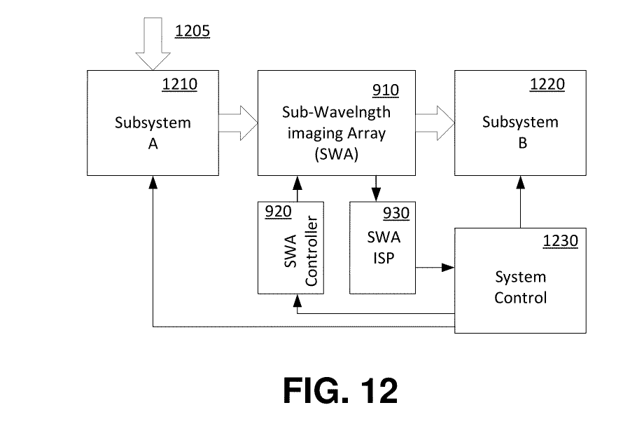

FIG. 12 illustrates a microfluidic system comprising a subwavelength imaging array for sample analysis. 1210 may represent an arbitrary block of microfluidic machinery, which includes the input of the substance 1205, and some circuitry built and operated for analysis, facilitating chemical or biological processing, and analysis, culture or molecule growing etc. Part of the substance may be directed onto subwavelength sensor 910, where it may be imaged. The obtained image, images or video stream may be used for multiple purposes, including the analysis of the substance and/or its components. After imaging the substance may be directed towards microfluidics circuitry 1220 for further processing or analysis. 1230 denotes a controller of the microfluidics system. It may use the results of image or video acquired on SWA as one of the inputs influencing the control flow. For example, the analyzed substance may be blood, and the acquired images or video flow may allow to distinguish count number of red blood cells per unit volume. SWA 910 may incorporate some of the structures and methods described in this disclosure, such as cross-talk reduction structures, shielded pixels for cross-talk calibration and measurement of the point spread function, electrostatic phased grid for electrostatically induced propagation of liquid sample, image in post-processing, etc. In operating of SWA in microfluidics system the synchronization between liquid advancing and image acquisition may be necessary. For example, if SWA acquired a sequence of images at certain frame-rate, while the liquid is flowing above it, the electrostatic phased array may be synchronized to advance the liquid by steps between the image integration intervals, and to halt liquid advancement during the image acquisition.

FIG. 12 illustrates only one of multiple possible configurations of use of the disclosed sensor.

What is claimed is:

1. A sub-wavelength imaging array comprising:
A two dimensional array of photo-sensitive pixels, operating in the certain wavelength band of visible, infrared or ultraviolet optical spectrum, where the size of some of the pixels does not exceed the wavelength of the said operating band.

2. A sub-wavelength array of claim 1, where the separation between some of the adjacent neighbor pixels does not exceed the wavelength of the operating band.

3. A sub-wavelength array of claim 2, covered with the back-end layers, where the optical isolation between the adjacent pixels is provided by the metal layers and cross-layer via connections, running along the boundary between the neighbor pixels, and extending at least partially through the height of the said back-end layers.

4. A sub-wavelength array of claim 2, at least some of the pixels are at least partially surrounded along the boundary by the reversely biased p-n region.

5. A sub-wavelength array of claim 2, where at least some of the pixels have reversely biased p-n layer below their active photo-sensing element.

6. A sub-wavelength array of claim 2, where the adjacent pixels are isolated by semiconductor etching along their boundary.

7. A sub-wavelength imaging array of claim 2, where some of the pixels are optically shielded.

8. An image processing method, applied to the image acquired on the imaging array of claim 7, comprising:
Calculation of point spread function by averaging of the image around the shielded pixels;
Applying the calculated point spread function for image deblurring

9. An imaging array of claim 2, further comprising an phased electrostatic grid, comprising:
A means for advancing the liquid over the sensor

10. An imaging array of claim 9, where the said means for advancing the liquid is the electrostatic phased array.

11. An imaging array of claim 9, and a means for synchronizing liquid advancing with the image acquisition period.

12. A pixel crosstalk calibration structure, comprising:
An array of at least 2 pixels, where some pixels in the array are covered with light-blocking layer, and some are not covered by the said layer.

13. A crosstalk calibration structure of claim 12, where the uncovered pixel is surrounded by the covered pixels.

14. A crosstalk calibration structure of claim 12, covered pixel is surrounded by the uncovered pixels.

15. A method of pixel cross-talk calibration, where the signals detected by the covered pixels of structure of claim 12 are measured and normalized by the signal detected by the uncovered pixel.

16. A method of pixel cross-talk calibration, where the relative signal decrease of the uncovered pixels of structure of claim 12 are measured as a function of distance from the covered pixel.

17. A signal processing method, where the signal measured by the image sensor is corrected by signal processing adjusting the signal values by the pixel cross-talk value.
